(19) United States
(12) Patent Application Publication
(10) Pub. No.: US 2025/0374032 A1
(43) Pub. Date: Dec. 4, 2025

(54) METHODS, ARCHITECTURES, APPARATUSES AND SYSTEMS FOR REPORTING PRECODING FEEDBACK IN SENSING

(71) Applicant: InterDigital Patent Holdings, Inc., Wilmington, DE (US)

(72) Inventors: Javier Lorca Hernando, Madrid (ES); Yasser Mestrah, Uxbridge (GB); Mohammad Heggo, Lewisham (GB); Arman Shojaeifard, London (GB); Alain Mourad, Ascot (GB)

(21) Appl. No.: 18/675,433

(22) Filed: May 28, 2024

(51) Int. Cl. H04W 8/22; H04B 17/318; H04L 5/00

(52) U.S. Cl. CPC H04W 8/22; H04B 17/328; H04L 5/0051

(57) ABSTRACT

Procedures, methods, architectures, apparatuses, systems, devices, and computer program products for reporting precoding information to a transmit/receive point (TRP) includes a wireless transmit/receive unit (WTRU) transmitting sensing capability information to the TRP, receiving, from the TRP, configuration information including reporting conditions based on the sensing capability information, and receiving a reference signal from the TRP. The methods further include the WTRU determining a first set of scatterers that meet first reporting conditions and generating first precoding information for each of the first set of scatterers based on at least one CIR of the received RS, and determining a second set of scatterers that meet second reporting conditions and generating a second precoding information for each scatterer of the second set of scatterers and each scatterer of the first set. The WTRU then generates a report including each of the precoding information, and transmits the report to the TRP.

### BACKGROUND

The present disclosure is generally directed to the fields of communications, software and encoding, including, for example, to methods, architectures, apparatuses, systems related to the reporting of precoding feedback information and measuring the effectiveness of the precoding feedback information in sensing systems.

### SUMMARY

In certain representative embodiments, a method or procedure, and related apparatuses for reporting precoding information to a transmit/receive point (TRP), the method including a wireless transmit/receive unit (WTRU) transmitting sensing capability information about the WTRU to the TRP, the WTRU receiving, from the TRP, configuration information based on the sensing capability information, where the configuration information includes first reporting conditions and second reporting conditions. The method further includes the WTRU receiving a reference signal (RS) from the TRP, determining, by the WTRU, a first set of scatterers, where each scatterer of the first set of scatterers meets the first reporting conditions, and generating a respective first precoding information for each scatterer of the first set of scatterers based on at least one channel impulse response (CIR) of the received RS, and the WTRU determining a second set of scatterers, where each scatterer of the second set of scatterers meets the second reporting conditions, and generating a respective second precoding information for each scatterer of the second set of scatterers and each of the at least one scatterer of the first set of scatterers, where the second precoding information is indicative of an effectiveness of precoding with respect to the at least one scatterer of the first set of scatterers. The WTRU then generates a report including the first precoding information and the second precoding information, and transmits the report to the TRP.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communication system;

FIG. 1B is a system diagram illustrating an example WTRU that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a graph illustrating example CIRs obtained from antenna ports of a sensing transmitter;

FIG. 3 is an exemplary sensing system to sense scatterers and clutter sources;

FIG. 4 is another exemplary sensing system to sense scatterers and clutter sources;

FIG. 5 shows a first graph of example CIRs and a second graphs illustrating precoding gain (PG) and cross-scatterer gain (CSG) for scatterers that may be shown within the sensing system shown in FIG. 3;

FIG. 6 is a depiction of the contents of an exemplary sensing precoding report;

FIG. 7 is a flowchart of illustrative actions performed by a wireless transmit/receive unit (WTRU) and a transmit-receive point (TRP) for the reporting of precoding feedback for sensing which may be implemented using the sensing system illustrated in FIG. 3;

FIG. 8 is a flowchart of an illustrative process for reporting precoding information to a TRP which may be implemented using the sensing system illustrated in FIG. 3; and

FIG. 9 is a flowchart of an illustrative process for providing at least one RS from a TRP which may be implemented using the sending system illustrated in FIG. 3.

### DETAILED DESCRIPTION

In the following detailed description, numerous specific details are set forth to provide a thorough understanding of embodiments and/or examples disclosed herein. However, it will be understood that such embodiments and examples may be practiced without some, or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

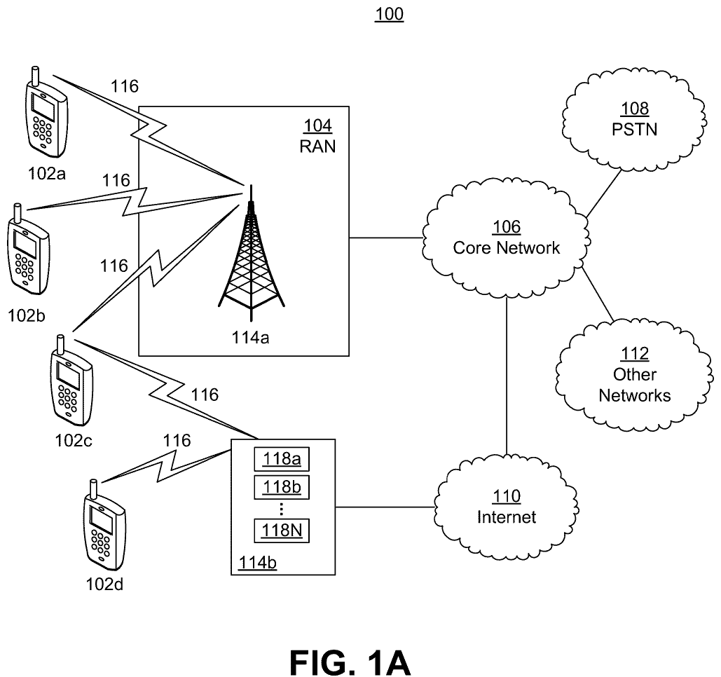

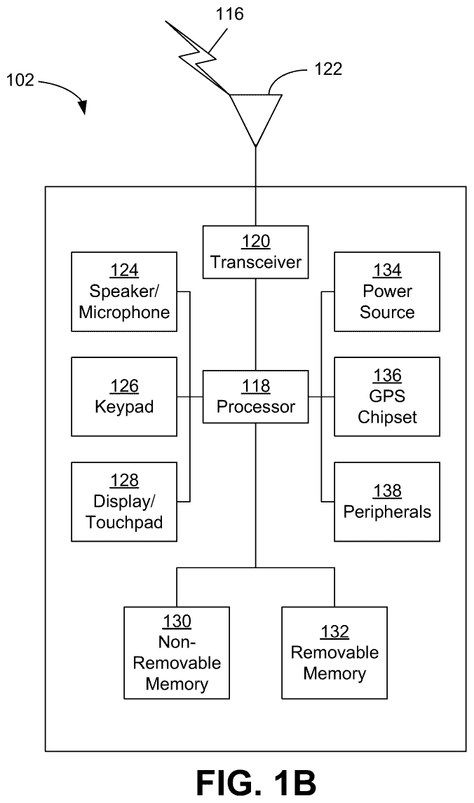

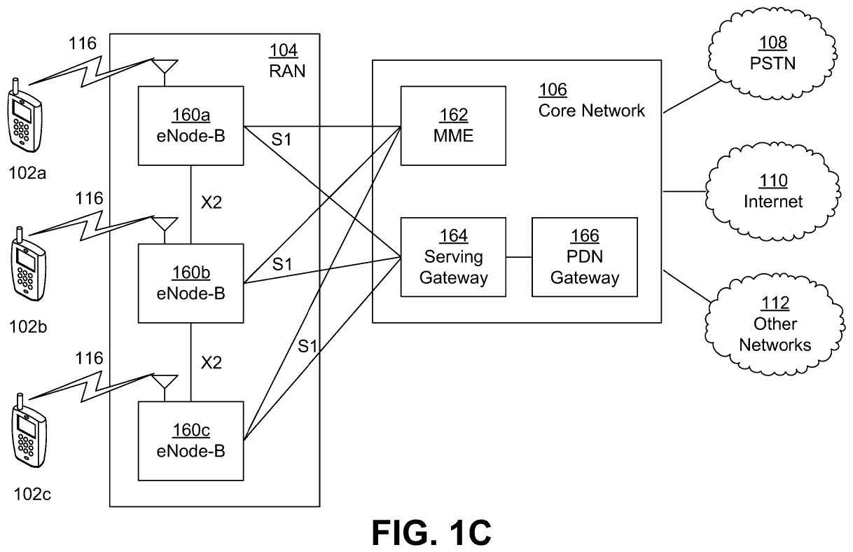

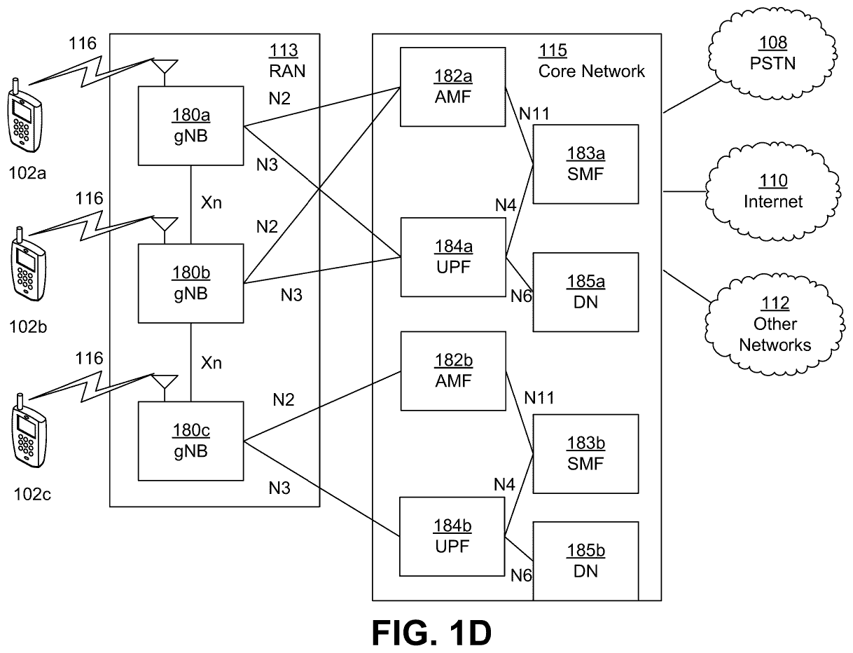

The methods, apparatuses and systems provided herein are well-suited for communications involving both wired and wireless networks. An overview of various types of wireless devices and infrastructure is provided with respect to FIGS. 1A-ID, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, BSs, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a New Radio Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements. In some embodiments, each of the base station 114a, 114b may include one or more antenna ports (e.g., 118a, 118b, . . . , 118N) as shown for base station 114b in FIG. 1A.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHZ, 80 MHZ, and/or 160 MHz wide channels. The 40 MHz, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHZ, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Overview

The present disclosure describes methods, procedures and systems to report precoding feedback information for sensing target detection without impacting the macroscopic characteristics of the channel used to extract the sensing information, and to measure the effectiveness of the precoding feedback information for reinforcing the detection of one or more intended sensing targets.

The methods and procedures disclosed herein for reporting precoding feedback information may be implemented in bistatic and multi-static sensing systems. The term “sensing” may herein refer to an estimation of one or more spatial characteristics (e.g., an absolute position or a relative position, 3D orientation, speed) of one or more objects that are not connected to the sensing system under consideration. In some wireless systems, sensing may be considered during a usage scenario, e.g., when using integrated sensing and communications (ISAC).

There are at least three sensing modes that may be (e.g., commonly) established depending on the relative positions of a transmitter and a receiver, or receivers, with respect to a target sensing object to be sensed. Monostatic sensing may refer to a sensing system where the transmitter entity and receiver entity are co-located for an estimation of one or more of a target object's position, velocity, and orientation. Monostatic sensing may be performed by a BS (e.g., a TRP) or a user equipment (UE) (e.g., a WTRU). Bistatic sensing may refer to a sensing system where the transmitter entity and receiver entity are not co-located for sensing (e.g., a TRP acting as the transmitter entity and a WTRU as the receiver entity, or vice versa). Multi-static sensing may refer to a sensing system where multiple receiving entities may be configured to sense one or more target objects with a transmitting entity that is not co-located with any one of the receiving entities. Each sensing mode may be implemented to detect one or more objects.

For purposes of clarity, the methods and procedures described hereinafter may (e.g., generally) refer to sensing systems implemented with one of bistatic sensing modes and multi-static sensing modes.

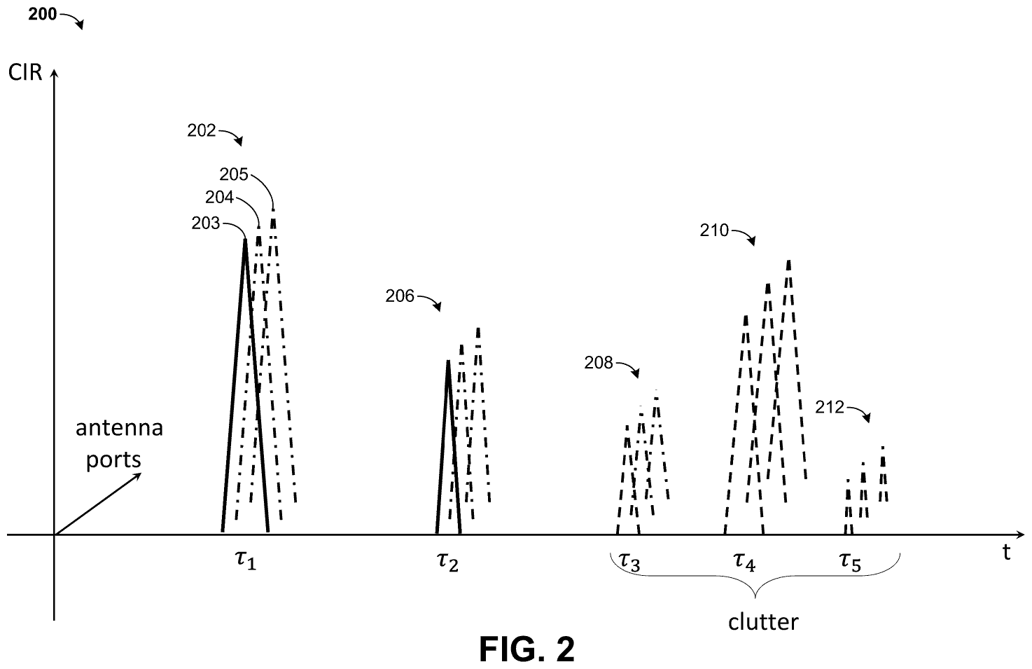

The sensing of objects (e.g., target objects) may be based on measurements of the CIR, as shown in FIG. 2. Each peak (e.g., highest measured value of a respective CIR) contains information about the object such as Time of Arrival (ToA), Time Difference of Arrival (TDoA), Reference Signal Received Path Power (RSRPP), Angle of Arrival (AoA), Reference Signal Carrier Phase (RSCP), and Radar Cross Section (RCS). An example of CIRs is shown in the graph 200 of FIG. 2. In such an example, CIRs may be obtained from RSs transmitted by N antenna ports of the a transmitting entity, wherein one or more CIRs may show a target (e.g., a respective scatterer) and other objects or clutter.

FIG. 2 illustrates graph 200 to show CIRs (e.g., CIRs 203, 204, and 205) received by a receiving entity (e.g., a WTRU or TRP) from one or more scatterers over time. In some embodiments, the transmitting entity has more than one antenna port. Therefore, at time T1, the receiving entity (e.g., the WTRU or TRP) may detect a first set of CIRs 202 corresponding to one object (e.g., first CIR 203 corresponding to an RS transmitted from a first antenna port, a second CIR 204 corresponding to an RS transmitted from a second antenna port, and third CIR 205 corresponding to an RS transmitted from a third antenna port). Graph 200 also illustrates that, at time 12, the receiving entity detects a second object based on a second set of CIRs 206. In some embodiments, the receiving entity may also detect clutter, as shown by the third set of CIRs 208 at time T3, fourth set of CIRs 210 at time 14 and fifth set of CIRs 212 at time T5. In some embodiments, one or more of the sets of CIRs are received from the same object or clutter. For example, the third set of CIRs 208 and the fifth set of CIRs 212 may be determined to be from the same clutter (e.g., based on one or more information contained in one or more CIR of the corresponding sets of CIRs).

In some embodiments, sensing may involve a beam scanning procedure by the transmitter entity, where sweeping beams are generated by the transmitting entity (e.g., transmitter) to cover a targeted sensing area in an environment (e.g., following a sequential order) and reflections of the sweeping beams are captured by the receiving entity (e.g., receiver). In some embodiments, a measurement entity (e.g., a WTRU) may detect one or more signal copies reflected by the environment from one or more sensing beams, and perform measurements, e.g., of the delay, power, AoA of the detected signal copies to differentiate each of the scatterers from each other and from the clutter produced by undesired sources.

In some embodiments, a sensing system may include one or more TRPs as transmitting entities for sensing and one or more WTRUs as receivers that perform sensing measurements and report the sensing measurements back to a wireless network communicatively coupled to the WTRUs. Other sensing systems may be implemented in accordance with the present disclosure, e.g., including one or more WTRUs, one or more BSs, or a transmitting WTRU and a receiving BS.

Insufficient sensing accuracy may arise in low signal-to-noise ratio (SNR) conditions (e.g., in case of non-line of sight (NLOS) sensing links), or when any of the desired (e.g., target-related) signal information (e.g. ToA, AoA) is too close to those from clutter or any other (e.g., non-target related) objects, hindering the ability to detect a target object. This phenomenon may be referred to as multi-scatterer interference, which may be similar to inter-user interference in multi-user MIMO systems.

Spatial precoding is a technique used in communications that may improve the quality of a signal received by a user or group of users (e.g., WTRUs), multiplex layers of information, and leverage the characteristics of the channel. However, precoding techniques used in communications may alter the timing and angular characteristics of the CIR with respect to a non-precoded transmission. In some embodiments, these deficiencies may occur because the channel transfer function may be changed due to the convolution (e.g., implicitly) applied by spatial precoding. For example, when the frequency response is changed because of applying a frequency-dependent precoding matrix (e.g., per Precoding Resource Group (PRG)), the peaks in the CIR may be shifted and modified, thus impairing the time domain properties (e.g., ToA and RSCP) of the sensing signal. In some embodiments, the angular characteristics of the transmitted signals (e.g., the angular power distribution) may also be altered, which would also result in incorrect AoA measurements of the reflected signals.

As discussed herein, a WTRU, that may be part of a sensing system, that is capable of receiving DL RS for sensing may be configured to receive a configuration to report precoding feedback information for sensing including RS resources, assistance information, a first set of scatterers and a second set of scatterers with their respective reporting conditions (e.g., first reporting conditions and second reporting conditions, respectively), update procedures, and termination procedures. The WTRU may be further configured to provide, for each scatterer in the first set of scatterers that meet the first reporting conditions, a sensing precoding report including one or more of (a) antenna ports, RS resources, scatterer identifiers (IDs), (b) precoding vector for sensing based on the CIR peaks values at the antenna ports, and (c) a precoding gain indicating the ratio between the an first amplitude of a CIR peak of a respective scatterer when applying the precoding vector and a second amplitude of a CIR peak of the respective scatterer when not applying the precoding vector. In some embodiments, a subset of scatterers is partitioned into scatterer pairs, each scatterer pair including one scatterer from the first set of scatterers that meets the first reporting conditions, and one scatterer from the second set of scatterers that meets the second reporting conditions. The WTRU may be further configured to report, for each scatterer pair of the scatterer pairs, one or more of (a) antenna ports, RS resources, scatterer IDs, (b) sensing measurements, accuracy information, and (c) one or more precoding effectiveness metrics involving scatterers from the first set and the second set of scatterers (e.g., CSG, cross-scatterer dot product (CSDP), cross-scatterer correlation coefficient (CSCC), and a ratio of a sensing metric of the CIR peaks at each of the respective scatterers of the scatterer pair. The WTRU may also be configured to determine whether the precoding report is outdated, and when that determination is made, the WTRU may send an updated feedback report including new or updated values of sensing measurements, scatterers involved (e.g., using scatterer IDs), precoding vectors, and precoding effectiveness metrics. The WTRU may determine if conditions to stop reporting are met, if that determination is made, the WTRU may terminate any further reporting and may send an indication to the wireless network of the termination of reporting.

### Terminology

The terms “UE”, “sensing receiver” and “WTRU” may be used interchangeably to refer to any entity receiving sensing signals (e.g., reflected RS). The term “sensing transmitter” may refer to any suitable entity transmitting sensing signals (e.g., RS). In some embodiments, the term “sensing transmitter” may be used interchangeably with “TRP”, “gNB” and “BS”. The terms “intended scatterer”, “target”, “target object”, and “sensing target” may be used interchangeably to refer to an object whose characteristics are intended to be sensed, where the object is not wirelessly connected to the implemented sensing system. In some embodiments, the terms “scatterer”, “object” and “sensing object” may be used interchangeably to refer to any object (e.g., intended to be sensed or not intended to be sensed) that is not wirelessly connected to the sensing system under consideration. The terms “clutter” and “clutter source” may be used to describe an object, or set of objects, whose presence may lead to undesired reflected signals or scattered signals that are not intended to be sensed (e.g., reflected signals or scattered signals from ground, sea, buildings, birds, cars, or parts of urban furniture). The term ToA may denote the time at which a given multipath component (MPC) is measured. For example, the ToA may be measured with respect to a start time of a subframe when measuring the MPC. The terms “CIR peak” or “power delay profile (PDP) peak” may be used interchangeably to refer to a presence of a correlation above a threshold between a received signal and a corresponding transmitted sensing signal for a ToA that characterizes a multipath delay. The terms “environment impulse response”, “CIR”, “sensing channel state”, and “sensing channel state information” (CSI) may be used interchangeably to refer to any CSI characterizing a radio environment being sensed by a sensing system. The term “quasi co-located” (QCL) may be used interchangeably to refer to antenna ports that share certain macroscopic channel characteristics (e.g., average delay and Doppler spread).

### Principles and Observations

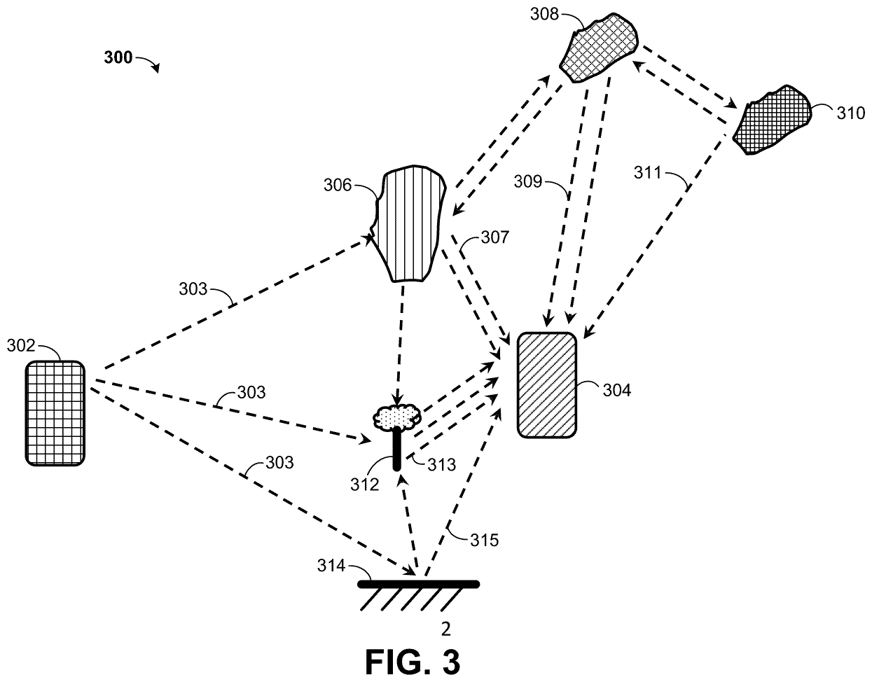

FIG. 3 shows a sensing system 300 to sense scatterers (e.g., first scatterer 306, second scatterer 308, and third scatterer 310) and clutter sources (e.g., first clutter source 312 and second clutter source 314). The sensing system 300 includes a sensing transmitter 302 configured to transmit signals (e.g., RS 303), and a sensing receiver 304 configured to receive scattered signals or reflected signals, including signals scattered or reflected from one of the scatterers (e.g., first scattered signal 307 from first scatterer 306, second scattered signal 309 from second scatterer 308, and third scattered signal 311 from third scatterer 310) signals scattered or reflected from one of the clutter sources (e.g., first clutter signal 313 from first clutter source 312 and second clutter signal 315 from second clutter source 314).

The cellular scenario shown in sensing system 300 of FIG. 3 shows sensing receiver 304 (e.g., UE, WTRU) that is configured to sense the environment by performing sensing measurements to derive spatial information (e.g., location, speed, and orientation) about the surrounding objects (e.g., first scatterer 306, second scatterer 308, and third scatterer 310, first clutter source 312 and second clutter source 314) as determined by sensing system 300 or the application being performed by sensing system 300. In some embodiments, sensing receiver 304 may be referred to as a measurement entity.

As an example, in the bistatic sensing scenario of FIG. 3, a sensing transmitter 302 may send one or more RS 303 that is captured by sensing receiver 304 which may be configured to determine a location and characteristics (e.g., position, orientation, velocity, object dimension, object materials, and object type such as a pedestrian or a car) of one or more targets (e.g., first scatterer 306, second scatterer 308, and third scatterer 310) in the environment. The sensing receiver 304 may be impacted by capturing reflections or diffractions from clutter sources (e.g., first clutter source 312 and second clutter source 314), such as the ground or a tree and from other objects (e.g., non-target related objects) existing in the same environment as the target objects (e.g., first scatterer 306, second scatterer 308, and third scatterer 310). In some embodiments, RS 303 may be scattered or reflected between two or more scatterers or clutter sources (e.g., from first scatterer 306 to second scatterer 308, from second scatterer 308 to third scatterer 310, from third scatterer 310 to second scatterer 308, from second scatterer 308 to first scatterer 306, from first scatterer to first clutter source 312, from second clutter source 314 to first clutter source 312). In some embodiments, a multi-static sensing scenario includes multiple sensing receivers (e.g., sensing receiver 304), each configured to measure sensing measurements and transmit the sensing measurements to the network to which the sensing receivers are communicatively coupled.

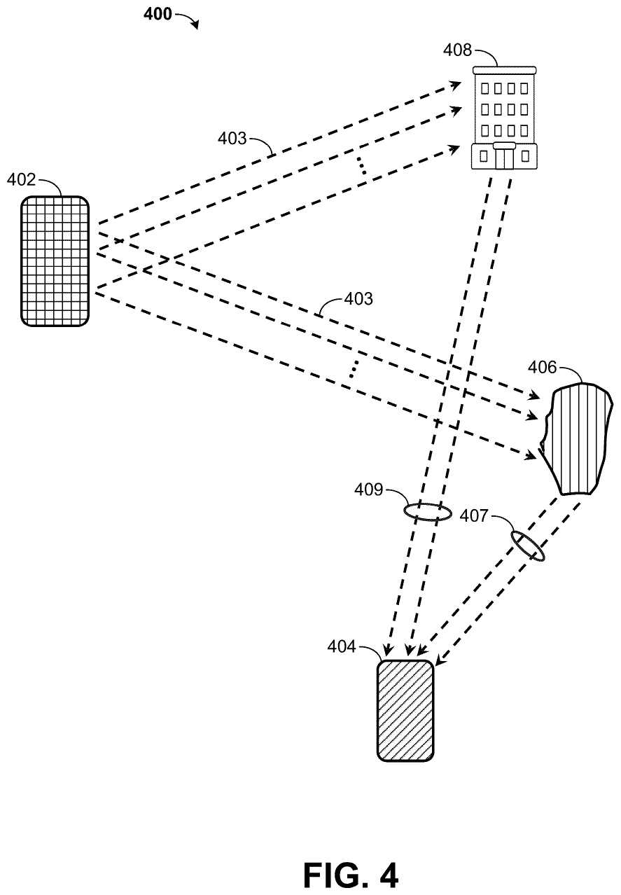

FIG. 4 illustrates another exemplary sensing system 400 that may be configured to sense scatterers (e.g., scatterer 408 and target 406) and clutter sources. Sensing system 400 includes sensing transmitter 402 that may be configured to transmit one or more RS 403 and sensing receiver 404 configured to receive one or more reflected or scattered signals (e.g., fourth scattered signal 409 from scatterer 408 and fifth scattered signal 407 from target 406). FIG. 4 shows an exemplary combined channel response at sensing receiver 404 that contains a cascaded contribution of a channel between (a) sensing transmitter 402 and (b) one of scatterer 408 and object 406 (e.g., a Tx-scatterer channel) and a channel between (c) one of scatterer 408 and target 406 and (d) sensing receiver 404 (e.g., a scatterer-Rx channel). In some embodiments, sensing system senses more than one targets (e.g., target 406) and/or more than one scatterer (e.g., scatterer 408).

Sensing transmitter 402 (e.g., a TRP) may include any number of transmit-receive antennas, such as in a Massive Multiple Input-Multiple Output (M-MIMO) configuration, with up to N antenna ports for the transmission of sensing signals (e.g., RS 403). In some embodiments, each antenna port of the N antenna ports of transmitter 402 (e.g., TRP) may have a unique RS configuration (e.g., RS resources) for transmitting RS.

A suitable RS (e.g., RS 403) for sensing measurements may be implemented in the form of an existing signal-type that may be re-purposed for sensing, such as the DL Positioning Reference Signal (PRS) or the Uplink (UL) Sounding Reference Signal for Positioning (SRSp) used in 5th Generation (5G) New Radio (NR), or a dedicated sensing RS. Descriptions provided herein do not make any assumptions regarding a type or structure of the RS (e.g., RS 403) used for sensing measurements in a sensing system (e.g., sensing system 400). Similarly, a suitable RS for CSI acquisition may be any one of existing signal types, such as Channel State Information-Reference Signal (CSI-RS), Synchronization Signal Burst (SSB), or any other suitable physical signal. In addition, in some embodiments, each channel at each sensing transmitter (e.g., sensing transmitter 402) may experience spatial stationarity. For example, individual antenna elements of the sensing transmitter 402 may experience similar macroscopic channel characteristics (e.g., ToAs, AoAs) across the antenna array of the sensing transmitter 402.

In some embodiments, discussions provided herein may be applicable to any signal waveform. For example, an Orthogonal Frequency Division Multiplexing (OFDM)-like waveform, like Cyclic Prefix Orthogonal Frequency Division Multiplexing (CP-OFDM) or Discrete Fourier Transform-spread-Orthogonal Frequency Division Multiplexing (DFT-s-OFDM), may be used in accordance with the present disclosure, and may be referred to in the descriptions provided herein including discrete samples in the time domain or frequency domain. In some embodiments, other waveform types may be similarly used.

### Benefits

The methods, procedures, and systems provide herein may facilitate performing sensing tasks by (a) reporting a set of preferred precoding vectors that may maximize the power level of one or more peaks in the CIR corresponding to the sensing targets (e.g., target 406) to be sensed, (b) decreasing the power level of the peaks in the CIR corresponding to other scatterers (e.g., scatterer 408) to minimize their impact on the CIR, (c) providing information to the network on the expected performance improvement when applying the reported precoding vectors, such as the precoding gain at the CIR peaks of the target (e.g., target 406), the relative SNR improvement with respect to other scatterers (e.g., scatterer 408), and the degree of correlation between scatterers, and (d) increasing the detection probability for sensing target objects (e.g., target 406), resulting in avoiding additional resource requirements such as RS (e.g., RS 403).

### Reporting of Precoding Feedback for Sensing

Methods and procedures described herein may be related to the identification, characterization, and reporting of precoding feedback information for sensing by a WTRU in a sensing system. As shown in the exemplary scenario in FIG. 3, a set of scatterers (e.g., 306, 308, and 310) and clutter sources (e.g., 312 and 314) may be illuminated by the N antenna ports of sensing transmitter 302 (e.g., a TRP), yielding CIR responses (e.g., 203, 204, 205) obtained by the receiver 304, as shown in FIG. 2.

In some embodiments, a CIR peak or PDP peak may refer to (a) a CIR or PDP value above a pre-configured CIR or PDP threshold or a predetermined CIR or PDP value, or (b) a correlation value between the received sensing signal and the transmitted sensing signal above a correlation threshold or predetermined correlation value. In some embodiments, the CIR peak or PDP peak includes information (e.g., power, delay and/or angular information) that are characteristic of the object that produced the reflected signal corresponding to the CIR or PDP peak.

### WTRU Capabilities

In some embodiments, the WTRU may receive and decode a first network request (e.g., received through Radio Resource Control (RRC) signaling) to provide sensing capability information related to the support of precoding feedback information for sensing. In some embodiments, the WTRU may receive and decode the first network request following a random-access procedure. In some embodiments, the WTRU generates a sensing capability information message including sensing capability information related to the support of sensing precoding feedback information. The sensing capability information contained in the WTRU sensing capability information message may include one or more of the following: (a) sensing processing capabilities (e.g., inverse frequency transform capabilities, a maximum number of samples), (b) sensing frequency ranges, (c) sensing bandwidth, (d) sensing modes (e.g., monostatic, bistatic, multi-static), (e) sensing priorities, (f) sensing spatial resolution, (g) support of ToA or TDoA determination and related time resolutions, (h) support of AoA determination and related AoA resolution, (i) support of RCS determination, (j) support of RSRPP determination and related power resolution, (k) support of carrier phase measurements and related phase resolution, (1) sensing doppler resolution, (m) reflectivity sensitivity, i.e., a minimum power, minimum SNR, or minimum absolute amplitude, for signal reflections to be detectable by the WTRU, (n) supported codebooks for sensing precoding, and (o) supported precoding metrics for sensing (e.g., PB, CSG, cross-scatterer correlation, and a ratio of a sensing metric). In some embodiments, the WTRU may send the WTRU sensing capability information message through RRC signaling, e.g., over a Physical Uplink Shared Channel (PUSCH). The WTRU sensing capability information may then be used by the network to optimize its configuration and resource allocation for sensing.

### WTRU Configuration

The WTRU may be configured to report sensing precoding feedback information once one or more information is received (e.g., information received from a control channel or data channel via RRC configuration, Downlink Control Indicator (DCI) information, or Medium Access Control-Control Element (MAC CE) signaling). Reporting sensing precoding feedback information may occur once one or more of the following is received: (a) threshold amplitude, power, or SNR, of a CIR peak, (b) information about the sensing RS resources for CIR estimation (e.g., CSI-RS, PRS), such as time/frequency allocation, bandwidth allocation, symbol and comb offsets, periodicity, and antenna ports (e.g., of the sensing transmitter), (c) assistance information to perform inverse frequency transformations for obtaining CIR responses such as frequency range, bandwidth, frequency layer identifier (e.g., Positioning Frequency Layer Identifier (PFL-ID)), bandwidth part (e.g., Bandwidth Part Identifier (BWP-ID)), and a number of Fast Fourier Transform (FFT) samples, (d) spatial relationships between antenna ports for sensing, including information about antenna ports that (1) are co-located in a same sensing transmitter (e.g., a TRP) and (2) beam, e.g., in the form of configured Transmission Configuration Indication (TCI) states with associated QCL characteristics, (e) positioning information, which may be represented as the ToA of the Line of Sight (LOS) component for each sensing TRP, AoAs, coordinates of the WTRU and sensing TRPs, 3D orientation of the WTRU and the TRP, and LOS likelihoods, (f) measurements that may be performed, e.g., ToA, TDoA, AoA, absolute or relative RSRPP, RSCP, doppler spectrum, and RCS, (g) a precoding vector applied by the network in the transmission of sensing RS resources, which may be represented by an index in a pre-defined codebook of precoding vectors for sensing, or an identity in case the precoding vector is not provided, (h) one or more precoding codebooks from which sensing provides feedback, such as labels to pre-defined tables, (i) update reporting conditions for updating the sensing precoding reports, e.g., determining that a change in the WTRU position or WTRU velocity exceeds a threshold or predetermined value, detecting a change in any of the CIR characteristics (e.g., the number of MPCs, the respective SNRs or RSRPP, or respective target velocity), or determining that a time duration has elapsed, (j) terminate reporting conditions for the termination of the sensing precoding reports, e.g., determining that a velocity of the WTRU and/or the scatterers are below a threshold or predetermined value, or determining a time duration has elapsed, (k) information related to one or more scatterers (e.g., AoAs, ToAs, or any suitable ID of one or more scatterer) in an environment being sensed by the sensing system to provide precoding feedback information for sensing, wherein scatterers in each set may be characterized by one or more of the following: (1) a subset of antenna ports involved, e.g., as a range of values, or a label to a pre-defined port range, (2) MPC number in the estimated CIR, (3) an absolute ToA or a relative ToA (e.g., with respect to another MPC), (4) AoA (e.g., specified with respect to a known orientation, or given by the rotation angles or Euler angles), (5) RCS (e.g., in dB or natural units according to a pre-defined format), (6) a threshold RSRPP or threshold SNR, (7) a type of scatterer (e.g., a label identifying ‘target’, ‘scatterer’, or ‘clutter’), (8) a value, or a distribution of values (e.g., a probability density function (PDF) that is one of Gaussian, Log-Normal, Weibull, Rayleigh, or a range of values), of any of the sensing measurements (ToA, TDoA, AoA, RCS, RSCP, RSRPP, or doppler) that correspond to known clutter sources (e.g., sea, ground, etc.), and (1) reporting conditions for a first set of scatterers and a second set of scatterers.

In some embodiments, the reporting conditions for each set of scatterers may be provided as one or more of: (1) first reporting conditions for the scatterers in the first set, which may include one or more of: (A) an SNR or RSRPP below a threshold or predetermined SNR/RSRPP value, (B) uncertainty in any one of the sensing metrics, e.g., AoA, ToA, TDoA, RSRPP, RSCP, RCS, or object's location, above a uncertainty threshold or predetermined uncertainty value, (C) WTRU velocity below a threshold or predetermined WTRU velocity value, (2) second reporting conditions for the scatterers in the second set, which may include one or more of: (A) SNR or RSRPP above a threshold or predetermined SNR/RSRPP value, (B) an absolute difference in AoA, or ToA, below a threshold or predetermined absolute difference in AoA/ToA value, the absolute difference measured with respect to at least one of the scatterers in the first set that meets the first reporting conditions, (C) the difference (e.g., measured as the absolute difference or the Kullback-Leibler divergence) between the PDF or set of values of any one of the sensing metrics, e.g., ToA, AoA, RSCP, or RCS, and a pre-defined clutter source, wherein the difference is below a threshold or predetermined difference value, and (3) an explicit indication to report precoding feedback information on a subset of scatterers of the first set and the second set of scatterers, specified by any of one of their respective MPC number, ToA, or AoA, over a configured or pre-determined time window or time period.

In some embodiments, the WTRU may receive a re-configuration message from the network containing updated configuration parameters for reporting sensing precoding feedback information, e.g., from a control channel or data channel via RRC configuration, DCI information, or MAC CE signaling. The re-configuration message may include some or all of the above information which may be included in a configuration message. In addition, when the WTRU receives a re-configuration message, its reception may override some or all of a configuration previously received and configured by the WTRU.

### Measurement of CIR Responses

In some embodiments, the WTRU may receive a set of RS resources for sensing in the form of, e.g., a SSB, CSI-RS, PRS, or a dedicated RS for sensing, as per the sensing configuration information received by the WTRU. In one example, the WTRU may be configured by the network to measure at least one of the ToA, TDoA, AoA, absolute or relative RSRPP, RSCP, doppler spectrum, or RCS, with an associated time from the resources (e.g., an allocated measurement time window). The WTRU may perform the configured measurement in the allocated measurement time window indicated to the WTRU. In another example, the allocated measurement time window may be configured by at least one of a start time or end time of the window (e.g., in terms of symbol index, slot index, frame index, absolute time, or relative time with respect to a reference point), a duration of the window (e.g., in terms of number of symbols, slots, frames, subframes, or seconds), and periodicity of the window (e.g., in terms of number of symbols, slots, frames, subframes, or seconds).

In another example, the WTRU may receive multiple RSs from one or more transmitting antenna ports for sensing (e.g., from different TRPs and/or a single TRP). In that case, the WTRU may perform multiple preconfigured measurements at each of the different channel responses obtained from the available TRPs and antenna ports for sensing. In some embodiments, for the WTRU to measure at each of the different channel responses, the WTRU may perform at least one or more of the following actions to obtain the respective CIR peaks in the first set of scatterers and the second set of scatterers that are subject to computation of precoding vectors and precoding effectiveness metrics. The WTRU may be configured to obtain channel frequency responses at the configured RS resources. The WTRU may obtain the channel frequency responses by removing the known values of the RS complex symbols and performing interpolation of the resulting responses over the desired frequency region. The WTRU may be further configured to obtain corresponding time-domain CIR responses. In some embodiments, the WTRU obtains the corresponding time-domain CIR responses by performing inverse frequency transformations, e.g., by using Inverse Discrete Fourier Transforms on the obtained frequency responses. In some cases, the WTRU may obtain PDP responses by computing an absolute square magnitude of the received CIR responses. In some embodiments, the WTRU may be configured to keep CIR peaks or PDP peaks whose powers or SNRs exceed a minimum configured RSRPP threshold or SNR threshold, or whose peak correlation value between the received signal and the transmitted sensing signal is above a threshold or predetermined peak correlation value, and to discard all other CIR or PDP peaks. The WTRU may be configured to keep the CIR peaks or PDP peaks that are received within a preconfigured ToA or delay window, and further configured to discard all the other CIR peaks or PDP peaks. In some embodiments, the WTRU may be configured to compare the CIR responses or PDP responses against a preconfigured CIR response or PDP response represented as a function of time. The WTRU may select the CIR peaks such that a difference between the PDF of the measured CIR response or PDP response, and one or more of the preconfigured CIR response or PDP responses, are below a preconfigured threshold or predetermined value.

The WTRU may also be configured to perform the inverse frequency transformation based on the capability of the WTRU. The WTRU may receive at least one assistance information for performing the inverse frequency transformation. For example, the network may indicate a RS carrier frequency range for which the WTRU may perform the inverse frequency transformation. In such an example, the network may indicate to the WTRU information in terms of one or more of a start frequency and stop frequency (e.g., in terms of Hz, number of Resource Elements (REs), or number of Resource Block (RBs)), a frequency offset with respect to an indicated reference frequency (e.g., Absolute Radio-Frequency Channel Number (ARFCN)), a frequency bandwidth (e.g., in terms of Hz, number of RBs, or number of REs), a frequency layer identifier (e.g., PFL-ID), or a subset of the carrier bandwidth to be used for sensing (e.g., a BWP-ID). In another example, the WTRU may indicate a number of samples used for the frequency transformation (e.g., number of samples for inverse-FFT).

### Computation of Precoding Vectors and Metrics for Selected Scatterers of the First Set

In some embodiments, the WTRU may check the first reporting conditions for the first set of scatterers. For each of the scatterers in the first set that meet the first reporting conditions, whose CIR peaks were obtained in a previous step by measuring CIR responses, the WTRU may obtain one or more precoding vectors that may maximize the power level of the corresponding CIR peak or PDP peak by applying the one or more precoding vector on transmission of a RS.

With reference to the sensing system 400 of FIG. 4, precoding vectors for target 406 may be defined by one or more complex vector, depending on a precoding strategy, the complexity, or any other implementation constraints of sensing system 400.

For example, a precoding vector v ( ) for a target j may be a complex vector defined as the CIR value of the j-th peak from each antenna port i of the N antenna ports, as shown in equation 1:

$${v}^{( j )} = \{ {β}_{j} {H}_{i}^{( j )} , i = 0 , … , N - 1 \} . \qquad ( eq . 1 )$$

where

$${H}_{i}^{( j )}$$

represents contributions of the channel between the sensing transmitter (e.g., from antenna port i) and target j, and B; represents contributions of the channel between target j and the sensing receiver. Therefore, the CIR value of the j-th peak from a respective antenna port k may be represented as

$${β}_{j} {H}_{k}^{( j )} .$$

In some embodiments, the precoding vector v^{(j)} for target j may be a complex vector determined based on a set of unit-amplitude complex exponentials containing an absolute phase of the j-th CIR peak at each antenna port i of the N antenna ports, as shown in equation 2:

$${v}^{( j )} = \{ {e}^{j {φ}_{i}^{( j )}} , i = 0 , … , N - 1 \} \qquad ( eq . 2 )$$

where

$${φ}_{i}^{( j )} = arg {β}_{j} {H}_{i}^{( j )} .$$

In some embodiments, the precoding vector v^{(j)} for target j may be a complex vector determined based on a set of unit-amplitude complex exponentials containing the differences between the phases of the j-th CIR peak at a subset of antenna ports (e.g., antenna port i) and a known antenna port i₀, that may be pre-defined, predetermined, or indicated by the network, e.g., via QCL relationships. The following equations 3 and 4 show the complex vector based on the set of unit-amplitude complex exponentials containing the differences between the phases described herein:

$${v}^{( j )} = \{ {e}^{j Δ {φ}_{i}^{( j )}} , i = 0 , … , N - 1 \} , \qquad ( eq . 3 )$$

$${Δφ}_{i}^{( j )} = arg {β}_{j} {H}_{i}^{( j )} - arg {β}_{j} {H}_{{i}_{0}}^{( j )} = arg {H}_{i}^{( j )} - arg {H}_{{i}_{0}}^{( j )} . \qquad ( eq . 4 )$$

In some embodiments, the complex value of the j-th CIR peak may include contributions of the channel between the sensing transmitter and the target

$$j ( {H}_{i}^{( j )} )$$

and contributions of the channel between target j and the sensing receiver (βⱼ). The contributions of the channel between target j and the sensing receiver (βⱼ) may be shared by scattered or reflected signals received by sensing receiver and therefore this contribution is removed when computing for relative phases

$${Δφ}_{i}^{( j )}$$

as shown in equation 4.

In some embodiments, the precoding vector may be further approximated by another precoding vector selected from a discrete set of possibilities contained in a codebook for sensing (e.g., DFT vectors), which represents a best approximation to an ideal vector according to some pre-defined criteria, such as a value of Mean Square Error (MSE) or a minimum Euclidean distance to the ideal vector. In some cases, entries in a codebook for sensing may be selected by an index in a pre-defined table (e.g., a priori) known by the WTRU.

In some embodiments, precoding vectors can be represented in a specified digital format in a compressed mode or an uncompressed mode, e.g., by a number of bits in the amplitude, an Euler rotation in the phase, or an index in a table of pre-defined amplitude or phase values.

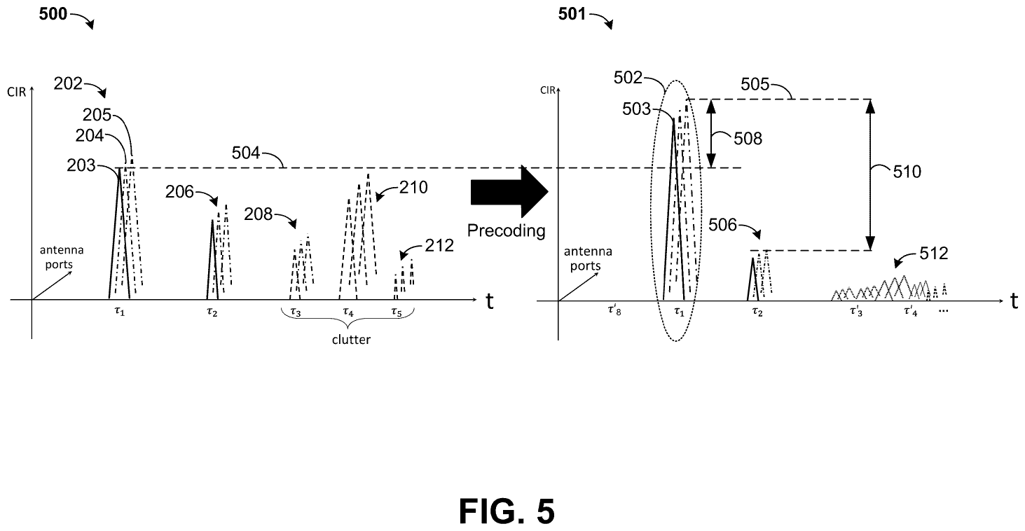

A PG may also be calculated for each determined precoding vector, the PG representing the ratio between a first amplitude, or first power level, of the j-th CIR peak when applying the precoding vector and a second amplitude, or second power level, of the j-th CIR peak when not applying the precoding vector, as shown in FIG. 5. In some cases, the PG may be represented in decibels (dB), natural units, according to a specified format, an index in a table of pre-defined values, or a category field (e.g., ‘high’/‘mid’/‘low’), as a figure of merit for an increase in power level obtained when applying a corresponding precoding vector for sensing.

As an example, PG for target j (e.g., PG^{(j)}) may be determined by using equation 5:

$$P {G}^{( j )} = 20 log \frac{\vert 〈 {H}^{( j )} , {v}^{( j )} 〉 \vert}{{max}_{i} \vert {H}_{i}^{( j )} \vert} \qquad ( eq . 5 )$$

where

$$〈 a , b 〉 = {Σ}_{i = 0}^{N - 1} {a}_{i} {b}_{i}$$

denotes a scalar or dot product across the antenna ports (e.g., for each antenna port i, from antenna port 0 to antenna port N−1) and

$$\vert a \vert = \sqrt{{Σ}_{i = 0}^{N - 1} {a}_{i}^{2}}$$

may be defined as the modulus operation. In other embodiments, PG^{(j)} may be calculated by using the following equation 6:

$$P {G}^{( j )} = 20 log \frac{\vert 〈 {H}^{( j )} , {v}^{( j )} 〉 \vert}{\vert {H}_{{i}_{0}}^{( j )} \vert} \qquad ( eq . 6 )$$

where i₀ is a (e.g., a priori) known antenna port.

In some embodiments, a precoding vector may be associated to more than one scatterer, such as when several scatterers in the first set of scatterers share one or more commonalities in their channel responses (e.g., when the difference between their respective AoAs is below a threshold or a predetermined AoA difference value). However, in such embodiments, the corresponding PGs of these several scatterers that share one or more commonalities may be different as they depend on their respective instantaneous channel conditions.

Computation of Precoding Effectiveness Metrics for Selected Pairs of Scatterers from the First and Second Sets

In some embodiments, for each precoding vector, the WTRU may check the second reporting conditions for each of the scatterers in the second set of scatterers. As a result, the WTRU may select a list of scatterer pairs (e.g., scatterer j, scatterer p) each scatterer pair including a j-th scatterer from the first set of scatterers that meets the first reporting conditions and a p-th scatterer from the second set of scatterers that meets the second reporting conditions. A list of scatterer pairs may be selected to cover a subset of scatterer combinations between the first set and second set of scatterers. One intention of selecting the list of scatterer pairs is to determine if, as a result of providing precoding information to a j-th scatterer from the first set of scatterers, a p-th scatterer from the second set of scatterers is reinforced as well (e.g., due to highly correlated CIRs from each of the j-th scatterer and the p-th scatterer), leading to a poor effectiveness metric of the provided precoding information.

In some cases, the WTRU may identify each pair of scatterers by their corresponding MPC numbers in the CIR, or their ToA or AoA values, or by using pre-defined labels (e.g., a priori) known by the WTRU to point to specific peaks in the CIR. In some embodiments, each of the first set and second set of scatterers may include one or more of a same scatterer.

FIG. 5 shows a first graph 500 of example CIRs (e.g., first CIR 203, second CIR 204, third CIR 205) and a second graph 501 illustrating example CIRs with a one or more precoding vector applied (e.g., first CIR applied with a precoding vector 503), along with example precoding effectiveness metrics (e.g., PG 508 and CSG 510) for scatterers that may be shown within the sensing system shown in FIG. 3.

For each selected pair of scatterers (e.g., scatterer j, scatterer p) where scatterer j meets the first reporting conditions and scatterer p meets the second reporting conditions, the WTRU may determine one or more precoding information (e.g., precoding effectiveness metrics) that may quantify a relative improvement in the CIR peak power level of scatterer j obtained from applying the determined precoding vector when compared to the power level of scatterer p when scatterer j and scatterer p are not the same scatterer (e.g., j≠p).

For example, scatterer j may be represented by the first set of CIRs 202 at time T1 in first graph 500 and a first set of CIRs applied with a precoding vector 502 at time T1 in second graph 501, and scatterer p may be represented by the second set of CIRs 206 at time 12 in first graph 500 and the second set of CIRs applied with a precoding vector 506 at time 12 in second graph 501. In addition, each of the third set 208, fourth set 210, and fifth set 212 of CIRs, which represent reflected signals received from clutter sources, when applied with one or more precoding vectors, correspond to one or more of the CIRs included in the third set of CIRs applied with precoding vectors 512.

Precoding effectiveness metrics corresponding to respective CIRs applied with one or more precoding vectors may include any one or more of CSGs (e.g., CSG 510), CSDP or CSCC.

A CSG (e.g., CSG 510) between the j-th scatterer and p-th scatterer (CSG^{(j,p)}) may be determined from the ratio of the received CIRs when applying the precoding vector (e.g., one of the set of CIRs 502, such as CIR 503) at the j-th and p-th scatterers, in dB or natural units, by using the following equation 7:

$$C S {G}^{( j , p )} = 20 log \vert \frac{〈 {H}^{( j )} , {v}^{( j )} 〉}{〈 {H}^{( p )} , {v}^{( j )} 〉} \vert \qquad ( eq . 7 )$$

where the complex value of the p-th CIR peak may include contributions of the channel between the sensing transmitter and scatterer p (H^{(p)}) and the complex value of the j-th CIR peak may include contributions of the channel between the sensing transmitter and scatterer j (H^{(j)}).

In some embodiments, a cross-scatterer correlation measuring a similarity between the CIR peaks of each scatterer of a pair of scatterers (e.g., scatterer j and scatterer p), when j≠p, may be represented as one or more a CSDP, a CSCC, or a magnitude representing a ratio of a sensing metric (e.g., the accuracy, the error variance, or the Cramer-Rao Bound) at the CIR peaks at the j-th and p-th scatterers respectively.

A correlation level represented by the CSDP for scatterer j and scatterer p (e.g., CSDP^{(j,p)}) between the received CIRs when applying the precoding vector at the j-th and p-th scatterers, may be determined using equation 8:

$${CSDP}^{( j , p )} = \vert 〈 {β}_{j} {H}^{( p )} , {v}^{( j )} 〉 \vert . \qquad ( eq . 8 )$$

A correlation coefficient (e.g., CSCC) for scatterer j and scatterer p (e.g., CSCC^{(j,p)}) represented by the correlation level normalized by a product of the norms of the vectors whose elements are the CIR peak responses at the N antenna ports may be determined using equation 9:

$${CSCC}^{( j , p )} = 20 log \frac{\vert 〈 {β}_{j} {H}^{( p )} , {v}^{( j )} 〉 \vert}{\vert {β}_{j} {H}^{( p )} \vert \vert {v}^{( j )} \vert} . \qquad ( eq . 9 )$$

In some embodiments, precoding effectiveness metrics included in precoding information may be expressed in dB, or natural units, according to a specified format, an index in a table of pre-defined values, or a category field (e.g., ‘high’/‘mid’/‘low’), as a figure of merit for the relative increase in power level obtained when applying precoding vectors for the sensing of scatterer j with respect to scatterer p.

### Reporting of Precoding Feedback for Sensing

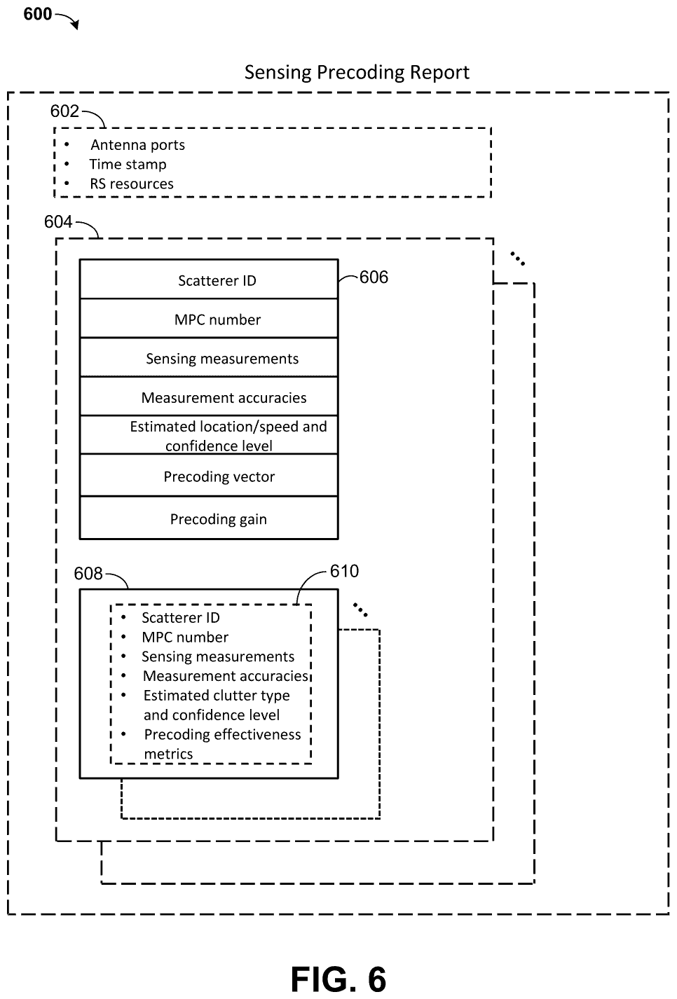

FIG. 6 is a depiction of the contents of an exemplary sensing precoding report 600. The WTRU may send a report on precoding feedback for sensing (e.g., report 600) containing, for each scatterer pair with a first scatterer of the first set of scatterers that meets the first reporting conditions and a second scatterer of the second set of scatterers that meets the second reporting conditions, one or more information in a compressed mode or uncompressed mode or as entries in a table. In some embodiments, report 600 includes information 602 including one or more of antenna ports used in the measurements provided in the report 600, a time stamp of the measurements, e.g., in absolute or relative time, or as a number of slots, frames, relative to a known reference time, or RS resources used in the measurements.

In some embodiments, report 600 may include a first list of scatterers from the first set of scatterers that meet the first reporting conditions, wherein each scatterer j (e.g., represented by first scatterer page 604) may be characterized by one or more of the following first precoding information 606: (a) a scatterer ID (e.g., a number, or a pre-defined label referring to specific peaks in the CIR), (b) an MPC number in the corresponding CIR, (c) sensing measurements, e.g., RCS, TOA, TDOA, AoA, RSRPP, RSCP, or doppler spectrum, or a range or a statistical distribution of measured values, (d) measurement accuracies (e.g., given as a variance or uncertainty in the corresponding magnitudes of measurement values), (e) an estimated location (e.g., in latitude/longitude, or as position coordinates in a suitable reference system) of the scatterer, its speed, and the object type (e.g., a label of type ‘car’, ‘pedestrian’, or ‘bicycle’) with a corresponding confidence level for the determined object type, (f) a computed sensing precoding vector represented in a specified digital format in a compressed mode or uncompressed mode, e.g., by a number of bits in the amplitude, an Euler rotation in the phase, an index in a codebook of sensing precoding vectors, or an index to a table of quantized amplitude or phase values, and (g) a computed precoding gain for a respective precoding vector, the precoding gain represented in dB or natural units according to a specified format, or an index in a table, or a category (e.g., ‘high’/‘mid’/‘low’).

In some embodiments, if more than one antenna port is used when determining sensing measurements, representative ToA and AoA values may be provided by averaging the magnitudes across the antenna ports (e.g., from a first antenna port to an Nth antenna port). When a LOS component is present in an environment being sensed by a sensing system, ToAs may be reported relative to a ToA corresponding to the LOS component, or in addition to the ToA corresponding to the LOS component. In some embodiments, AoA values may be reported with respect to a WTRU orientation vector, e.g., a vector perpendicular to a receive antenna panel or any other predefined WTRU surface whose coordinates may also be reported and may be represented as indexes in a table of predefined directions.

For each of the reported scatterers in the first set of scatterers (e.g., scatterer j represented by first scatterer page 604), a list of scatterers in the second set of second scatterers that meet the second reporting conditions may be provided, wherein each reported scatterer p (e.g., as represented by second scatterer page 608) of the second set of scatterers may be characterized, when j≠p, by one or more of the following second precoding information 608: (a) scatterer ID (e.g., a number, or a pre-defined label referring to specific peaks in the CIR), (b) a MPC number in the CIR, (c) sensing measurements, e.g., RCS, ToA, TDoA, AoA, RSRPP, RSCP, or doppler spectrum, or a range or a statistical distribution of measured values, (d) measurement accuracies (e.g., given as a variance or uncertainty in the corresponding magnitudes of measurement values), (e) estimated clutter type (e.g., a label of type ‘sea’, ‘ground’, or ‘foliage’) in case the sensing metrics are proximate to those of a pre-defined clutter source, and an associated confidence level of the estimated clutter type (e.g., determined as a Kullback-Leibler divergence or chi-square test), and (f) one or more precoding effectiveness metrics corresponding to the scatterer pair (e.g., scatterer j and scatterer p), each precoding effectiveness metric represented in dB or natural units according to a specified format, an index in a table, or a category (e.g., ‘high’/‘mid’/‘low’). The one or more precoding effectiveness metrics corresponding to the scatterer pair may include (1) CSG of scatterer j with respect to scatterer p, (2) CSDP between scatterer j and scatterer p, (3) CSCC between scatterer j and scatterer p, and (4) a magnitude representing a ratio of a sensing metric (e.g., the accuracy, the error variance, or the Cramer-Rao Bound) at the CIR peaks of each of scatterer j and scatterer p.

In some embodiments, the selected scatterers of the first set of scatterers and second set of scatterers and their respective precoding vectors, precoding gains and precoding effectiveness metrics may be reported in the form of a table, such as the one shown in Table 1, wherein K is the number of scatterers in the first set of scatterers that meet the first reporting conditions and Q is the number of scatterers in the second set of scatterers that meet the second reporting conditions. In some embodiments, some of the elements in the table may be empty or not determined, such as when a given combination of scatterers (e.g., jₖ, p_{q}) does not meet one or more of the first reporting conditions and the second reporting conditions. The information contained in the table (e.g., Table 1) may be further compressed or represented in any digital format suitable for reporting purposes, according to the implementation. In some embodiments, other precoding effectiveness metrics (e.g., CSCC) may also be reported as a part of the table, according to the implementation.

TABLE 1

| | Precoding | Precoding | | | | |
|---|---|---|---|---|---|---|
| | vector | gain | Scatterer p₁ | Scatterer p₂ | . . . | Scatterer p_{Q} |
| Scatterer j₁ | v^{(j}^{₁}⁾ | PG^{(j}^{₁}⁾ | CSG^{(j}^{₁}^{, p}₁), | CSG^{(j}^{₁}^{, p}₂), | . . . | CSG^{(j}^{₁}^{, p}_{Q}), |
| | | | CSDP^{(j}^{₁}^{, p}₁) | CSDP^{(j}^{₁}^{, p}₂), | . . . | CSDP^{(j}^{₁}^{, p}_{Q}) |
| Scatterer j₂ | v ^{(j}^{₂}⁾ | PG^{(j}^{₂}⁾ | CSG^{(j}^{₂}^{, p}₁), | CSG^{(j}^{₂}^{, p}₂), | . . . | CSG^{(j}^{₂}^{, p}_{Q}), |
| | | | CSDP^{(j}^{₂}^{, p}₁) | CSDP^{(j}^{₂}^{, p}₂) | . . . | CSDP^{(j}^{₂}^{, p}_{Q}) |
| . . . | . . . | . . . | . . . | . . . | . . . | . . . |
| Scatterer j_{K} | v^{(j}^{_{K}}⁾ | PG^{(j}^{_{K}}⁾ | CSG^{(j}^{_{K}}^{, p}₁), | CSG^{(j}^{_{K}}^{, p}₂), | . . . | CSG^{(j}^{_{K}}^{, p}_{Q}), |
| | | | CSDP^{(j}^{_{K}}^{, p}₁) | CSDP^{(j}^{_{K}}^{, p}₂) | . . . | CSDP^{(j}^{_{K}}^{, p}_{Q}) |

In some embodiments, the sensing precoding report 600 may be transmitted in an UL control or data channel, e.g., a Physical Uplink Control Channel (PUCCH) or PUSCH, and may be conveyed by an RRC control message, Uplink Control Indicator (UCI) signaling, or MAC CE.

There are several types of actions that the network may perform upon the reception of the sensing precoding report 600. These actions can be classified based on the network intention.

In some cases, the network is configured to rank scatterers in terms of the respective relative gain that may be obtained from sensing precoding (e.g., using one or more precoding vectors). As an example, the network may prioritize reported scatterers from the first set of scatterers having the highest possible PGs. Depending on the implementation, the network may leverage such rankings to assign priorities to scatterers when scheduling precoding transmissions.

In other cases, the network may be configured to prioritize scatterers from the first set of scatterers whose precoding effectiveness metrics with most scatterers from the second set are the best possible, e.g., scatterers with the highest CSG, lowest CSDP, or lowest CSCC. Depending on the implementation, the network may avoid precoding transmissions to scatterers whose precoding effectiveness metrics with other scatterers are above or below a threshold or predetermined precoding effectiveness metric value, or based on other conditions.

In some cases, the network may be configured to group scatterers based on their precoding vectors in such a way that similarities between the scatterers are leveraged to minimize resources consumption. As an example, the network may select precoding vectors and schedule transmissions in such a way that the CIR responses of multiple scatterers of the first set of scatterers are simultaneously reinforced.

In some embodiments, the network may increase the resources for sensing (e.g., the bandwidth, the power, the beamforming gain, the amount, or density, of RS resources) to improve on the detection accuracy for certain scatterers. Similarly, the network may switch to a different precoding codebook for sensing in response to poor precoding effectiveness metrics reported by the WTRU.

### Sensing Precoding Report Update

The WTRU may send a report update on precoding feedback for sensing containing, for each scatterer pair with a first scatterer of the first set of scatterers that meets the first reporting conditions and a second scatterer of the second set of scatterers that meets the second reporting conditions, one or more updated information in a compressed mode or uncompressed mode or as entries in a table.

In some embodiments, the WTRU may be configured to report precoding feedback for sensing over one or more measurement occasions. The WTRU may determine that the precoding feedback information in the a report (e.g., report 600) is outdated, or their corresponding measurements invalidated, based on one or more of the following triggering conditions (e.g., update reporting conditions) for precoding feedback update, as provided by the network as part of the WTRU configuration: (a) a change in any of the number of MPCs, ToAs, AoAs, amplitudes or phases of the CIR peaks, of any of the scatterers that exceeds a threshold or predetermined value, (b) an uncertainty in any one of the characteristics of the CIR peaks that exceeds a threshold or predetermined value, (c) a WTRU re-configuration message containing updated configuration parameters for reporting of precoding feedback for sensing, (d) a change in the number of scatterers whose absolute or relative power, or SNR, that is above or below a configured threshold or predetermined value for any one of the first reporting conditions or second reporting conditions, (e) a change in the detected RS resources, e.g., the generation or termination of one or more RS at their configured time-frequency locations, or the corresponding antenna ports, (f) an absolute or relative change in the WTRU position coordinates, or the WTRU 3D orientation, or both, that exceeds a threshold or predetermined value, (g) a time elapsed since the last reporting of scatterers and clutter information that exceeds an absolute or relative duration of time, e.g., a configured periodicity, and (f) a network request indicating that the precoding information is outdated.

Based on any of the above, the WTRU may perform new sensing measurements, obtain updated precoding feedback information for sensing and transmit a report update in an UL control or data channel containing one of more of updated information, (e.g., explicitly) through an RRC control message, UCI signaling, or MAC CE. In some embodiments, the report update includes updated information including one or more of an updated antenna ports involved in the measurements, a timestamp of the updated measurements, e.g., in absolute or relative time, or as a number of slots, frames, or relative to a known reference, or an updated RS resources employed to perform the updated measurements.

In some embodiments, the report update may include a list of new or updated scatterers of the first set of scatterers that meet the first reporting conditions, wherein each scatterer j may be characterized by one or more of the first updated precoding information, including an updated scatterer ID, an updated MPC number, updated sensing measurements, updated measurement accuracies, updated estimated location or speed, and confidence level, an updated precoding vector, and an updated precoding gain. In some embodiments, one or more of the first updated precoding information may remain unchanged from the corresponding first precoding information 606 of the report 600.

For each of the new or updated scatterers in the first set, a list of new or updated scatterers in the second set of scatterers that meet the second reporting conditions may be provided, wherein each scatterer p may be characterized by one or more of the second updated precoding information, including an updated scatterer ID, updated MPC number, updated sensing measurements, updated measurement accuracies, updated estimated clutter type and confidence level, and updated precoding effectiveness metrics. In some embodiments, one or more of the second updated precoding information may remain unchanged from the corresponding second precoding information 610 of the report 600.

### Sensing Precoding Feedback Termination

In some embodiments, the WTRU may be configured to report precoding feedback information for sensing for one or more measurements. The WTRU may determine that the precoding feedback reporting is to be terminated based on any of the following terminate reporting conditions for sensing precoding feedback termination, as provided by the network as part of the WTRU configuration: (a) the number of scatterers in the first set of scatterers whose absolute power or relative power, or SNR, is below a configured threshold or predetermined value for the first reporting conditions, (b) a WTRU velocity is above a threshold or predetermined WTRU velocity value, (c) a velocity of one or more of the scatterers is above a threshold or predetermined scatterer velocity value, (d) a time elapsed since the last reporting of precoding feedback information has exceeded a maximum absolute or relative duration of time, (e) a termination indication has been received from the network, or (f) a low-battery indication from the WTRU.

Based on any one of the above terminate reporting conditions, the WTRU may terminate the procedure for reporting sensing precoding feedback information and may send a control signal to the network containing a termination indication via a UL control or data channel carrying an RRC message, UCI signaling, or MAC CE.

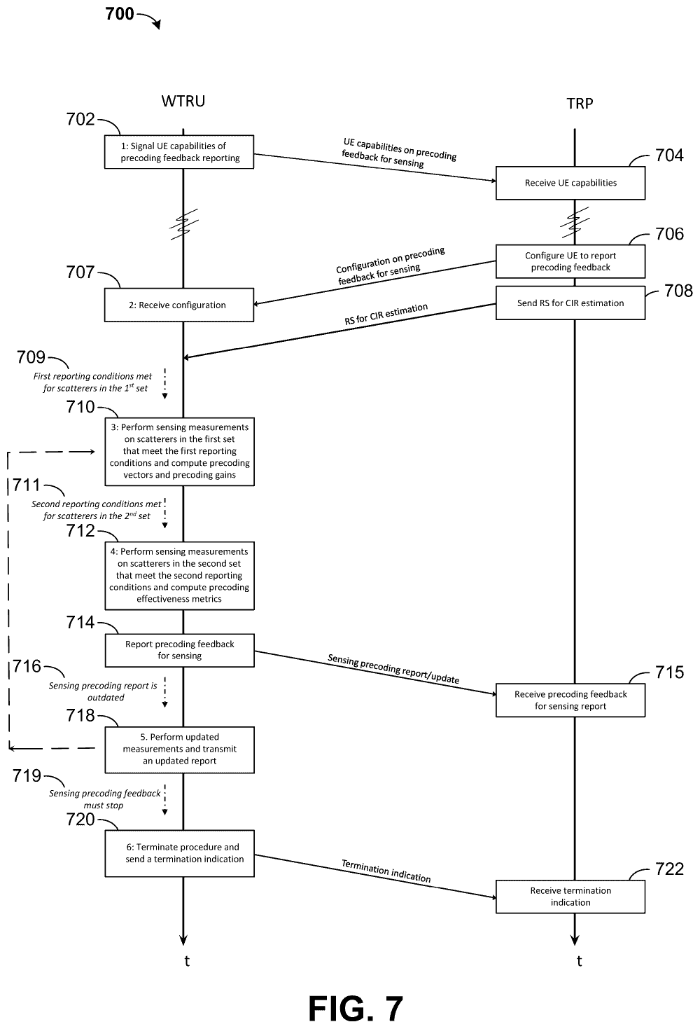

FIG. 7 illustrates flowchart 700 of illustrative actions performed by a WTRU and a TRP for the reporting of precoding feedback for sensing which may be implemented using the sensing system 300 illustrated in FIG. 3. In the embodiment exemplified in FIG. 7, the WTRU is capable of receiving DL RSs for sensing purposes. Although FIG. 7 shows a WTRU and TRP, the WTRU may be any suitable sensing receiver of a sensing system, and the TRP may be any suitable sensing transmitter of the sensing system.

At 702, the WTRU may send a sensing capabilities message onto the network (e.g., to the TRP), the sensing capabilities message including sensing capabilities information such as one or more of supported sensing measurements (e.g., ToA, TDoA, RSRPP, AoA and its resolution, RSCP, or RCS), supported feedback (e.g., sensing codebooks or precoding metrics for sensing), or associated parameters for sensing. In some embodiments, actions at 702 may be performed by WTRU after performing a random access or upon receiving a network request. Once the WTRU sends the sensing capabilities message onto the network, the TRP then receives the sensing capabilities message, at 704.

At 704, the TRP may receive the sensing capabilities message from the network. In some embodiments, the sensing capabilities message includes the capabilities of the WTRU on precoding feedback for sensing. Once the TRP receives the sensing capabilities message, the TRP may generate and transmit a configuration for the WTRU to report precoding feedback, at 706.

At 706, the TRP may generate a configuration for the WTRU based on the one or more of the sensing capabilities information included in the received sensing capabilities message and transmit the configuration onto the network.

At 707, the WTRU may receive the configuration for the WTRU generated by the TRP and configure the WTRU to report precoding feedback for sensing, by reporting any one or more of (a) threshold amplitude or power of a CIR peak to be considered for reporting, (b) RS resources for sensing (e.g., PRS or CSI-RS), periodicity, antenna ports for sensing, TCI states containing QCL information (c) assistance information (e.g., sensing beam spatial relationships, positioning information, or measurements to perform), (d) precoding vector used in the transmission by the network of RS resources for sensing (e.g., an index in a pre-defined codebook), or the identity in case precoding vector is not provided, (e) two sets of scatterers, wherein scatterers in each set are characterized by one or more of a subset of antenna ports involved, MPC number, absolute or relative ToA, AoA, RCS, threshold RSRPP or SNR, type of scatterer (e.g., target object, or clutter), or distribution of values of any of the sensing measurements for known clutter sources, (f) one or more precoding codebooks for sensing (e.g., as labels to pre-defined tables), (g) update reporting conditions for updating the sensing precoding reports, e.g., when detecting a change in the WTRU position or WTRU velocity exceeds a threshold or predetermined value, a change in the CIR characteristics (e.g., MPC number, SNR or RSRPP, or sensing uncertainties), or a change in the RS resources, or a time duration has elapsed, (h) terminate reporting conditions for the termination of the sensing precoding reports, e.g., when detecting a velocity of the WTRU and/or scatterers exceeds a threshold or a predetermined value, or a time duration has elapsed, or (i) reporting conditions for the first set of scatterers and the second set of scatterers, represented as one or more of: (1) first reporting conditions for the scatterers in the first set, which may include one or more of (A) determining that SNR or RSRPP is below a threshold or a predetermined SNR or RSRPP value, (B) determining that uncertainty in any of the sensing metrics exceeds a threshold or predetermined uncertainty value, (C) determining that WTRU velocity is below a threshold or predetermined WTRU velocity value, (2) second reporting conditions for the scatterers in the second set, which may include one or more of (A) determining that SNR or RSRPP exceeds a threshold or predetermined SNR or RSRPP value, (B) an absolute difference in AoA, or ToA, with at least one of the scatterers in the first set that meet the first reporting conditions that is below a threshold or predetermined value, (C) the difference between the PDF or set of values of any of the sensing metrics with a pre-defined clutter source is below a threshold or predetermined value, and (3) an (e.g., explicit) indication to report feedback on a subset of scatterers of the first and the second set of scatterers, e.g., as specified by any of their respective MPC number, ToA, or AoA, over a configured or pre-determined time window.

At 708, the TRP may send one or more RSs, on the network, to the WTRU for CIR estimation.

At 709, the WTRU determines a first subset of scatterers of the first set of scatterers that meet the first reporting conditions that may be included in the configuration for the WTRU received at 707.

At 710, the WTRU provides, for each scatterer j that satisfy the first reporting conditions in the first subset of scatterers, one or more first precoding information to the network in a sensing report. In some embodiments, the sensing report may be sent (e.g., explicitly) via UCI, MAC CE, RRC signaling, or (e.g., implicitly) through a selection of certain UL resources in a periodic, semi-persistent or aperiodic manner. The one or more first precoding information included in the sensing report includes antenna ports, time stamps, or RS resources, involved in the measurements, identifier for scatterer j, e.g., by using a respective MPC number, ToA, or a label, a precoding vector for sensing based on the value of the j-th CIR peak, and a PG representing a ratio between a first amplitude or power level of the j-th CIR peak when applying the precoding vector and a second amplitude or power level of the j-th CIR peak when not applying the precoding vector. In some embodiments, precoding vectors for sensing can be defined based on one or more of a complex vector defined as the CIR value of the j-th peak from the N antenna ports of the TRP, a complex vector generated from a set of complex exponentials containing the absolute phases of the j-th CIR peak from the N antenna ports of the TRP, a complex vector generated from a set of complex exponentials containing the difference between the phases of the j-th CIR peak at a subset of antenna ports (e.g., one or more of antenna port i) and a known antenna port i₀, which may be pre-defined, configured or indicated by the network, e.g., via QCL relationships, or an index in a precoding codebook for sensing that represents a best approximation, according to some pre-defined criteria, to the ideal precoding vector. In some embodiments, precoding vectors may be represented in a specified digital format (e.g., a number of bits in the amplitude or a Euler rotation in the phase) in a compressed mode or uncompressed mode, or as indexes in a pre-defined table. In addition, the PG may be represented in dB or natural units according to a specified format, an index in a table, or a category (e.g., ‘high’/‘mid’/‘low’). In some embodiments, the WTRU computes each of the precoding vectors and respective PGs for each of the scatterers of the first subset of scatterers.

At 711, the WTRU determines a second subset of scatterers of the second set of scatterers that meet the second reporting conditions that may be included in the configuration for the WTRU received at 707.

At 712, the WTRU determines, for each scatterer pair that includes scatterer j of the first subset of scatterers which meet the first reporting conditions and scatterer p of the second subset of scatterers which meet the second reporting conditions, one or more second precoding information that is to be included in the report along with the first precoding information. The one or more second precoding information included in the sensing report includes the identifiers (e.g., MPC numbers, ToA values, or labels) of scatterer j and scatterer p, sensing measurements, accuracies, or estimated clutter type and confidence level, and when scatterer j and scatterer p are not the same scatterer (e.g., j≠p), one or more precoding effectiveness metrics that may quantify the improvement in their relative CIR power levels when applying one or more corresponding precoding vectors included in the first precoding information of the sensing report. The one or more precoding effectiveness metrics may include one or more of a CSG representing a ratio between the power levels of the corresponding CIR peaks that result from applying the precoding vector included in the first precoding information of the report, a cross-scatterer correlation measuring a similarity between the CIR peaks of each scatterer of the scatterer pair, and a magnitude (e.g., value) representing a ratio of a sensing metric (e.g., accuracy, error variance, or Cramer-Rao Bound) at the CIR peaks of the corresponding scatterers of the scatterer pair. In some embodiments, the cross-scatterer correlation may be defined by a CSDP of the vectors whose elements are the CIR peak responses of the corresponding scatterers of the scatterer pair, corresponding to RSs transmitted from the N antenna ports. In other embodiments, the cross-scatterer correlation may be represented by a CSCC defined by the CSDP divided by the product of the norms of the vectors whose elements are the CIR peak responses corresponding to RSs transmitted from the N antenna ports.

At 714, the WTRU may report the precoding feedback information (e.g., first precoding information and second precoding information) to the TRP by transmitting the precoding sensing report created at 710 and 712.

At 715, the TRP receives the precoding feedback information including first precoding information and second precoding information. In some embodiments, the TRP is configured to determine precoding vectors and PGs based on the first precoding information and the second precoding information in the received report. The TRP may then generate and transmit at least one updated RS, where each updated RS is generated based on the determined precoding vectors and PGs.

At 716, the WTRU may determine that the sensing precoding report is outdated based on one or more of update reporting conditions being met. In some embodiments, the update reporting conditions may be met by one or more of determining that a change in the WTRU position or WTRU velocity exceeds a threshold or predetermined value, detecting a change in any of the CIR characteristics (e.g., the number of MPCs, the respective SNRs or RSRPP, or respective target velocity), or determining that a time duration has elapsed.

At 718, in response to determining that the sensing precoding feedback is outdated, the WTRU may generate and send an updated sensing report (e.g., such as the report update 700 in FIG. 7). The update report may be sent (e.g., explicitly) through UCI, MAC CE, or RRC signaling, or (e.g., implicitly) through a selection of certain UL resources. The updated sensing report may include one or more new or updated precoding information, including any one or more updates in the precoding information (e.g., first precoding information and second precoding information) that may have been included in the report transmitted at 714. In some embodiments, to generate the updated sensing report, the flowchart 700 proceeds back to 710 to perform actions related to 710, 712, and 714 for the updated sensing report.

At 719, the WTRU may determine that the sensing precoding reporting should be stopped based on one or more of terminate reporting conditions being met. In some embodiments, the update reporting conditions may be met by one or more of determining that the number of scatterers in the first set of scatterers whose absolute power or relative power, or SNR, is below a configured threshold or predetermined value for the first reporting conditions, determining that a WTRU velocity exceeds a threshold or predetermined WTRU velocity value, determining that a velocity of one or more of the scatterers exceeds a threshold or predetermined scatterer velocity value, determining that a time elapsed since the last reporting of precoding feedback information has exceeded a maximum absolute or relative duration of time, receiving a termination indication from the network, or (f) receiving a low-battery indication of the WTRU.

At 720, in response to determining that the sensing precoding reporting should be stopped based on one or more of the terminate reporting conditions, the WTRU may terminate reporting and signal a termination indication to the network via an uplink RRC message, UCI signaling, or MAC CE.

At 722, the TRP may receive the termination indication sent from the WTRU, indicating the termination of the sensing reporting.

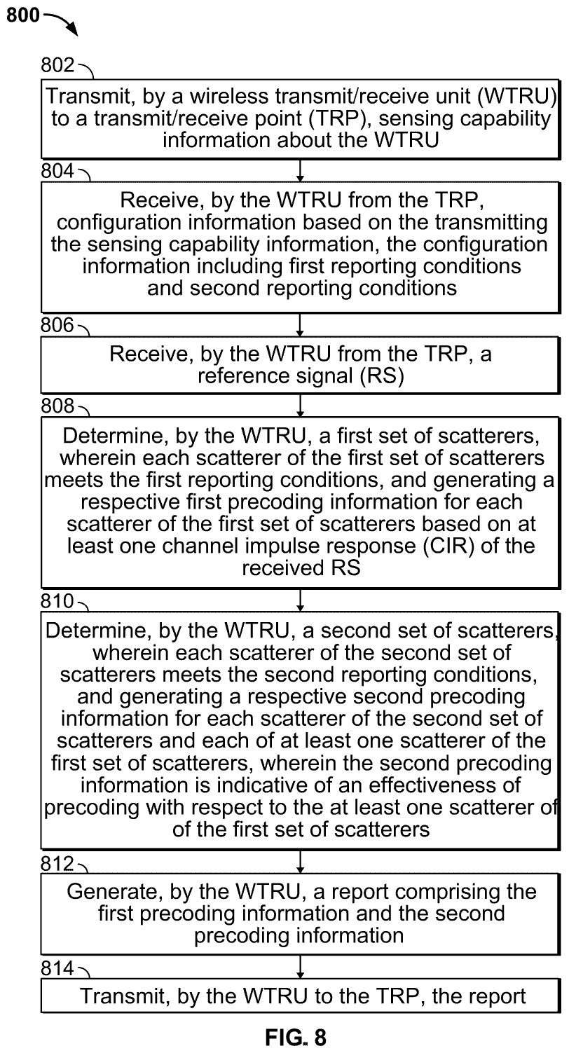

FIG. 8 shows a flowchart of an illustrative process 800 for reporting precoding information from a WTRU to a TRP using a wireless network, each of which may be implemented using the sensing system 300 illustrated in FIG. 3. Although process 800 refers to a WTRU and TRP, the WTRU may be any suitable sensing receiver, and the TRP may be any suitable sensing transmitter.

At 802, the WTRU transmits sensing capability information about the WTRU to the TRP. In some embodiments, the sensing capability information is transmitted as part of a WTRU sensing capability information message. The sensing capability information may include one or more of the following: (a) sensing processing capabilities (e.g., inverse frequency transform capabilities, a maximum number of samples), (b) sensing frequency ranges, (c) sensing bandwidth, (d) sensing modes (e.g., monostatic, bistatic, multi-static), (e) sensing priorities, (f) sensing spatial resolution, (g) support of ToA or TDoA determination and related time resolutions, (h) support of AoA determination and related AoA resolution, (i) support of RCS determination, (j) support of RSRPP determination and related power resolution, (k) support of carrier phase measurements and related phase resolution, (l) sensing doppler resolution, (m) reflectivity sensitivity, i.e., a minimum power, minimum SNR, or minimum absolute amplitude, for signal reflections to be detectable by the WTRU, (n) supported codebooks for sensing precoding, and (o) supported precoding metrics for sensing (e.g., PB, CSG, cross-scatterer correlation, and a ratio of a sensing metric). In some embodiments, the WTRU may send the WTRU sensing capability information message through RRC signaling, e.g., over a PUSCH.

At 804, the WTRU receives, from the TRP, configuration information based on the transmitting of the sensing capability information. In some embodiments, the configuration information includes first reporting conditions for determining a first set of scatterers and second reporting conditions for determining a second set of scatterers, where the first set and second set of scatterers are subsets of scatterers in an environment being sensed by the sensing system (e.g., WTRU and TRP).

At 806, the WTRU receives at least one RS from the TRP. In some embodiments, the RS received has been reflected or scattered by one or more scatterer, object or clutter source.

At 808, the WTRU determines the first set of scatterers, where each scatterer of the first set of scatterers meets the first reporting conditions, and generates a respective first precoding information for each scatterer of the first set of scatterers based on at least one CIR of a respective received RS of the at least one received RS. In some embodiments, each respective first precoding information includes sensing measurements and precoding vectors and corresponding precoding gains.

At 810, the WTRU determines the second set of scatterers, where each scatterer of the second set of scatterers meets the second reporting conditions, and generates a respective second precoding information for each scatterer of the second set of scatterers and each scatterer of at least one scatterer of the first set of scatterers. In some embodiments, the second precoding information is indicative of an effectiveness of precoding with respect to the at least one of the first set of scatterers.

At 812, the WTRU generates a report including the first precoding information generated at 808 and the second precoding information generated at 810.

At 814, the WTRU transmits the report to the TRP.

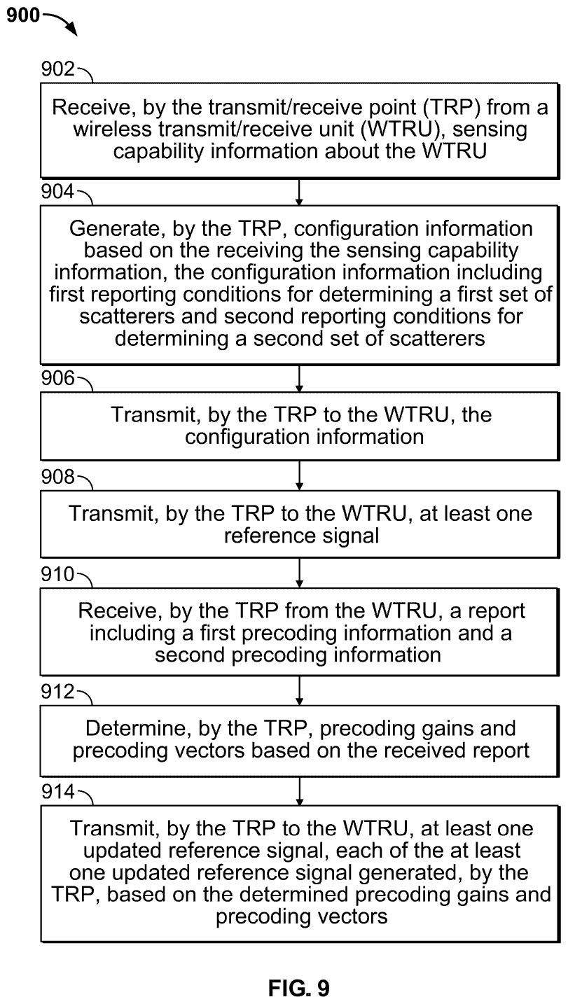

FIG. 9 shows a flowchart of an illustrative process 900 for providing at least one RS from a TRP to a WTRU using a wireless network, each of which may be implemented using the sending system 300 illustrated in FIG. 3. Although process 900 refers to a WTRU and TRP, the WTRU may be any suitable sensing receiver and the TRP may be any suitable sensing transmitter of a sensing system.

At 902, the TRP receives, from the WTRU, sensing capability information about the WTRU.

At 904, the TRP generates configuration information based on the sensing capability information received at 902. In some embodiments, the configuration information includes first reporting conditions for determining a first set of scatterers and second reporting conditions for determining a second set of scatterers, where the first set and second set of scatterers are subsets of scatterers in an environment being sensed by the sensing system (e.g., WTRU and TRP).

At 906, the TRP transmits the generated configuration information to the WTRU to configure the WTRU based on the configuration information.

At 908, the TRP transmits at least one RS to the WTRU. In some embodiments, each of the RSs is intended to be received by the WTRU for CIR estimation of the RSs. A suitable RS transmitted by TRP for sensing measurements may be implemented in the form of an existing signal-type that may be re-purposed for sensing, such as the DL PRS or the UL SRSp used in 5G NR, or a dedicated sensing RS. Similarly, a suitable RS for CSI acquisition may be any one of existing signal types, such as CSI-RS, SSB, or any other suitable physical signal.

At 910, the TRP receives a report from the WTRU, the report including a first precoding information and a second precoding information. In some embodiments, the first precoding information includes at least one sensing measurement, and precoding vectors and corresponding precoding gains. The second precoding information may be indicative of an effectiveness of precoding with respect to the at least one of the first set of scatterers that met the first reporting conditions. In some embodiments, the second precoding information includes one or more precoding effectiveness metrics represented in dB or natural units according to a specified format, an index in a table, or a category (e.g., ‘high’/‘mid’/‘low’).

At 912, the TRP determines precoding vectors and PGs based on the received report.

At 914, the TRP transmits at least one updated RS to the WTRU, where each updated RS of the at least one updated RS is generated, by the TRP, based on the determined precoding vectors and PGs at 912. In some embodiments, each updated RS transmitted by the TRP may improve the sensing of target objects and detecting clutter sources or un-intended objects (e.g., non-target objects).

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, BS, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method for reporting precoding information to a transmit/receive point (TRP), the method comprising:
transmitting, by a wireless transmit/receive unit (WTRU) to the TRP, sensing capability information about the WTRU;
receiving, by the WTRU from the TRP, configuration information based on the transmitting the sensing capability information, the configuration information comprising first reporting conditions and second reporting conditions;
receiving, by the WTRU from the TRP, a reference signal (RS);
determining, by the WTRU, a first set of scatterers, wherein each scatterer of the first set of scatterers meets the first reporting conditions, and generating a respective first precoding information for each scatterer of the first set of scatterers based on at least one channel impulse response (CIR) of the received RS;
determining, by the WTRU, a second set of scatterers, wherein each scatterer of the second set of scatterers meets the second reporting conditions, and generating a respective second precoding information for each scatterer of the second set of scatterers and each of at least one scatterer of the first set of scatterers, wherein the second precoding information is indicative of an effectiveness of precoding with respect to the at least one scatterer of the first set of scatterers;
generating, by the WTRU, a report comprising the first precoding information and the second precoding information; and
transmitting, by the WTRU to the TRP, the report.

2. The method of claim 1, wherein the receiving, by the WTRU from the TRP, the RS further comprises receiving the RS from at least one antenna port of the TRP.

3. The method of claim 1, wherein the sensing capability information comprises any one or more of supported sensing measurements, supported feedback information, or sensing parameters, wherein:
the supported sensing measurements comprises any one or more of time of arrival (ToA), time difference of arrival (TDoA), reference signal received power per path (RSRPP), angle of arrival (AoA), resolution, reference signal carrier phase (RSCP), or radar cross-section (RCS); and
the supported feedback information comprises any one or more of sensing codebooks or precoding metrics for sensing.

4. The method of claim 1, wherein determining the first set of scatterers and generating the respective first precoding information for each scatterer of the first set of scatterers comprises:
for each respective scatterer of the first set of scatterers that is determined to meet the first reporting conditions:
determining a precoding vector corresponding to the respective scatterer;
determining a precoding gain for the respective scatterer, the precoding gain indicative of a ratio between a first CIR amplitude when applying the precoding vector and a second CIR amplitude when not applying the precoding vector; and
generating the respective first precoding information for the respective scatterer, the respective first precoding information comprising the determined precoding vector and the determined precoding gain.

5. The method of claim 1, wherein determining the first set of scatterers and generating the respective first precoding information for each scatterer of the first set of scatterers comprises:
for each respective scatterer of the first set of scatterers that is determined to meet the first reporting conditions:
determining a scatterer identifier (ID) for the respective scatterer;
determining measuring information, the measuring information comprising one or more of a number of antenna ports of the TRP, one or more timestamps, and RS resources; and
generating the respective first precoding information for the respective scatterer, the respective first precoding information comprising the determined scatterer ID and measuring information.

6. The method of claim 1, wherein determining the second set of scatterers and generating the respective second precoding information for each scatterer of the second set of scatterers and at least one scatterer of the first set of scatterers comprises:
for each respective scatterer of the second set of scatterers that is determined to meet the second reporting conditions:
determining at least one precoding effectiveness metric corresponding to the respective scatterer of the second set of scatterers and a scatterer of the at least one scatterer of the first set of scatterers, wherein the at least one precoding effective metric is one or more of a cross-scatterer gain, cross-scatterer dot product, a cross-scatterer correlation coefficient, or a magnitude corresponding to a ratio of a sensing measurement; and
generating the respective second precoding information, the respective second precoding information comprising the at least one precoding effectiveness metric.

7. The method of claim 1, wherein determining the second set of scatterers and generating the respective second precoding information for each scatterer of the second set of scatterers and at least one scatterer of the first set of scatterers comprises:
for each respective scatterer of the second set of scatterers that is determined to meet the second reporting conditions:
determining a scatterer identifier (ID) for each of the respective scatterer of the second set of scatterers and a scatterer of the at least one scatterer of the first set of scatterers;
determining measuring information, the measuring information comprising one or more of a number of antenna ports of the TRP, one or more timestamps, and RS resources; and
generating the respective second precoding information, the respective second precoding information comprising the determined scatterer ID and measuring information.

8. The method of claim 1, wherein the configuration information comprises information about updating the report, the information about updating the report comprising update reporting conditions and the method further comprising:
determining, by the WTRU, that one or more of the first precoding information and the second precoding information is outdated based on the update reporting conditions; and
in response to the determining that one or more of the first precoding information and the second precoding information is outdated:
generating, by the WTRU, an updated report comprising an updated first precoding information and an updated second precoding information; and
transmitting, by the WTRU to the TRP, the updated report.

9. The method of claim 8, wherein the set of update reporting conditions comprises any one or more of:
determining that a first change in a CIR characteristic is greater than a first predetermined value;
determining that a second change in RS resources is greater than a second predetermined value;
determining that a third change in position coordinates of the WTRU is greater than a third predetermined value;
determining that a predetermined amount of time has elapsed since a previous reporting of precoding information; or
receiving a request to transmit the updated report.

10. The method of claim 1, wherein the configuration information comprises information about terminating reporting of the precoding information, the information about terminating reporting comprising terminate reporting conditions and wherein the method further comprises:
determining, by the WTRU, that reporting is to be terminated based on the terminate reporting conditions; and
in response to the determining that reporting is to be terminated, causing to terminate the reporting of the precoding information,
wherein the set of terminate reporting conditions comprises any one or more of:
determining that a number of scatterers in the first set of scatterers that meet the first reporting conditions is below a first predetermined value;
determining that a velocity of the WTRU is above a second predetermined value;
determining that a respective velocity of one or more scatterer in the first set of scatterers and the second set of scatterers is above a third predetermined value;
determining that a predetermined amount of time has elapsed since a previous reporting of precoding information;
receiving a termination indication from a wireless network communicatively coupled to the WTRU; or
detecting an indication of a low battery for the WTRU.

11. A wireless transmit/receive unit (WTRU) comprising a processor and at least one antenna port, the WTRU to:
cause to be transmitted, by the processor, sensing capability information about the WTRU to a transmit/receive point (TRP);
receive, by the at least one antenna port, configuration information from the TRP based on the transmission of the sensing capability information, the configuration information comprising first reporting conditions and second reporting conditions;
receive, by the at least one antenna port, a reference signal (RS) from the TRP;
determine, using the processor, a first set of scatterers, wherein each scatterer of the first set of scatterers meets the first reporting conditions, and generate a respective first precoding information for each scatterer of the first set of scatterers based on at least one channel impulse response (CIR) of the received RS;
determine, using the processor, a second set of scatterers, wherein each scatterer of the second set of scatterers meets the second reporting conditions, and generate a respective second precoding information for each scatterer of the second set of scatterers and each of the at least one of the first set of scatterers, wherein the second precoding information is indicative of an effectiveness of precoding with respect to at least one scatterer of the first set of scatterers;
generate, using the processor, a report comprising the first precoding information and the second precoding information; and
transmit, using the at least one antenna port, the report to the TRP.

12. The WTRU of claim 11, wherein the sensing capability information comprises any one or more of supported sensing measurements, supported feedback information, or supported sensing parameters, wherein:
the supported sensing measurements comprises any one or more of time of arrival (ToA), time difference of arrival (TDoA), reference signal received power per path (RSRPP), angle of arrival (AoA), resolution, reference signal carrier phase (RSCP), or radar cross-section (RCS); and
the supported feedback information comprises any one or more of sensing codebooks or precoding metrics for sensing.

13. The WTRU of claim 11, wherein to determine the first set of scatterers and to generate the respective first precoding information for each scatterer of the first set of scatterers the processor is to:
for each respective scatterer of the first set of scatterers that is determined to meet the first reporting conditions:
determine a precoding vector corresponding to the respective scatterer;
determine a precoding gain for the respective scatterer, the precoding gain indicative of a ratio between a first CIR amplitude when applying the precoding vector and a second CIR amplitude when not applying the precoding vector; and
generate the respective first precoding information for the respective scatterer, the respective first precoding information comprising the determined precoding vector and the determined precoding gain.

14. The WTRU of claim 11, wherein to determine the first set of scatterers and to generate the respective first precoding information for each scatterer of the first set of scatterers the processor is to:
for each respective scatterer of the first set of scatterers that are determined to meet the first reporting conditions:
determine a scatterer identifier (ID) for the respective scatterer;
determine measuring information, the measuring information comprising one or more of a number of antenna ports of the TRP, one or more timestamps, and RS resources; and
generate the respective first precoding information for the respective scatterer, the respective first precoding information comprising the determined scatterer ID and measuring information.

15. The WTRU of claim 11, wherein to determine the second set of scatterers and to generate the respective second precoding information for each scatterer of the second set of scatterers and at least one scatterer of the first set of scatterers the processor is to:
for each respective scatterer of the second set of scatterers that is determined to meet the second reporting conditions:
determine at least one precoding effectiveness metric corresponding to the respective scatterer of the second set of scatterers and a scatterer of the at least one scatterer of the first set of scatterers, wherein the at least one precoding effective metric is one or more of a cross-scatterer gain, cross-scatterer dot product, a cross-scatterer correlation coefficient, or a magnitude corresponding to a ratio of a sensing measurement; and
generate the respective second precoding information, the respective second precoding information comprising the at least one precoding effectiveness metric.

16. The WTRU of claim 11, wherein to determine the second set of scatterers and to generate the respective second precoding information for each scatterer of the second set of scatterers and at least one scatterer of the first set of scatterers the processor is to:
for each respective scatterer of the second set of scatterers that is determined to meet the second reporting conditions:
determine a scatterer identifier (ID) for each of the respective scatterer of the second set of scatterers and a scatterer of the at least one scatterer of the first set of scatterers;
determine measuring information, the measuring information comprising one or more of a number of antenna ports of the TRP, one or more timestamps, and RS resources; and
generate the respective second precoding information, the respective second precoding information comprising the determined scatterer ID and measuring information.

17. The WTRU of claim 11, wherein the configuration information comprises information about updating the report, the information about updating the report comprising update reporting conditions and wherein the processor is further to:
determine that one or more of the first precoding information and the second precoding information is outdated based on the update reporting conditions; and
in response to the determination that one or more of the first precoding information and the second precoding information is outdated:
generate an updated report comprising an updated first precoding information and an updated second precoding information; and
transmit the updated report to the TRP.

18. The WTRU of claim 17, wherein the set of update reporting conditions comprises any one or more of:
determine that a first change in a CIR characteristic is greater than a first predetermined value;
determine that a second change in RS resources is greater than a second predetermined value;
determine that a third change in position coordinates of the WTRU is greater than a third predetermined value;
determine that a predetermined amount of time has elapsed since a previous reporting of precoding information; or
receive a request to transmit the updated report.

19. The WTRU of claim 11, wherein the configuration information comprises information about terminating reporting of precoding information, the information about terminating reporting comprising terminate reporting conditions and wherein the processor is further to:
determine that reporting is to be terminated based on the terminate reporting conditions; and
in response to the determination that reporting is to be terminated, cause to terminate the reporting of the precoding information,
wherein the precoding information comprises the first precoding information and the second precoding information, and the set of terminate reporting conditions comprises any one or more of:
determine that a number of scatterers in the first set of scatterers that meet the first reporting conditions is below a first predetermined value;
determine that a velocity of the WTRU is above a second predetermined value;
determine that a respective velocity of one or more scatterer in the first set of scatterers and the second set of scatterers is above a third predetermined value;
determine that a predetermined amount of time has elapsed since a previous reporting of precoding information;
receive a termination indication from a wireless network communicatively coupled to the WTRU; or
detect an indication of a low battery for the WTRU.

20. A method for providing at least one reference signal (RS) from a transmit/receive point (TRP), the method comprising:
receiving, by the TRP from a wireless transmit/receive unit (WTRU), sensing capability information about the WTRU;
generating, by the TRP, configuration information based on the receiving the sensing capability information, the configuration information comprising first reporting conditions for determining a first set of scatterers and second reporting conditions for determining a second set of scatterers;
transmitting, by the TRP to the WTRU, the configuration information;
transmitting, by the TRP to the WTRU, at least one RS;
receiving, by the TRP from the WTRU, a report comprising a first precoding information and a second precoding information based on the at least RS;
determining, by the TRP, precoding gains and precoding vectors based on the received report; and
transmitting, by the TRP to the WTRU, at least one updated RS, each of the at least one updated RS generated, by the TRP, based on the determined precoding gains and precoding vectors.
